(19) United States
(12) Patent Application Publication
(10) Pub. No.: US 2013/0143584 A1
(43) Pub. Date: Jun. 6, 2013

(54) SYSTEM AND METHOD FOR USER CONTROL OF LOCATION DETERMINATION

(71) Applicant: Robert G. Mechaley, JR., Kirkland, WA (US)

(72) Inventor: Robert G. Mechaley, JR., Kirkland, WA (US)

(73) Assignee: Pendrell Corporation, Kirkland, WA (US)

(21) Appl. No.: 13/309,359

(22) Filed: Dec. 1, 2011

(51) Int. Cl. H04W 24/00

(52) U.S. Cl. 455/456.1

(57) ABSTRACT

A user can specify rules governing access to location information for a portable device. The rules can impose time, date and location restrictions as well as impose restrictions regarding the type of location information that can be disclosed. The rules for the portable device are stored in association with a unique portable device identifier. Multiple devices owned by the same user can have separate sets of rules or identical rules. A uniform application program interface is provided to permit a third party to request location information. When a request is received, the rules database is accessed to determine whether the request can proceed and what limitations are imposed on the location information. The allowed location information is returned to the third party requester. The system allows the user to allow all or block all location information and provides an override mechanism to allow location information in the event of an emergency call.

### BACKGROUND OF THE INVENTION

1. Field of the Invention

The present disclosure is related to location determination technology and, more specifically, to user control for such location determination technology.

2. Description of the Related Art

Early wireless communication devices, such as cell phones, were generally limited to simply audio communications. In contrast, modern communication devices, such as smart phones, computing tables, laptops, and other such portable devices permit the exchange of text data, image data, video streaming, the execution of application programs and the like in addition to conventional audio communications. Among the many things possible on modern wireless communication devices is location-based services. For example, the user of a portable device may wish to know the location of the nearest gas station or the nearest Italian restaurant. To respond effectively to such requests, it is necessary to determine the location of the portable device. While the user may sometimes wish to have his location be known, such as for location-based services, there may be other circumstances under which the user would prefer not to have the location be known.

Therefore, it can be appreciated that there is a significant need for user control of location determination technology. The present disclosure provides this, and other advantages, as will be apparent from the following detailed description and the accompanying figures.

### BRIEF DESCRIPTION OF THE SEVERAL VIEWS OF THE DRAWING(S)

FIG. 1 illustrates a system architecture constructed in accordance with the present disclosure.

FIG. 2 is a functional block diagram of a typical wireless communication device constructed in accordance with the present disclosure.

FIG. 3 illustrates the exchange of messaging in accordance with the present disclosure.

FIG. 4 is flow chart illustrating an exemplary embodiment of the operation of the system in accordance with the present disclosure.

### DETAILED DESCRIPTION OF THE INVENTION

The evolution of portable devices has enabled multiple methods of determining their location. For example, many portable devices include GPS. Some location determination methods, such as GPS, are controllable at a very rudimentary level on the device. For example, the user can control GPS by turning it on and off. Other means of location are not controllable by the user. For example, triangulation of WiFi access points, are not under control of the user. Thus, users do not have a means for complete and granular control of the location of a portable device that they carry and may be providing information to third parties useful in determining the portable device's location and thereby providing their own location. Furthermore, third parties may use application or hardware interfaces in the portable device to gain this information without the user's knowledge or consent. The system and method described herein provide a means for complete granular control of direct and indirect location information from a portable device while providing a uniform means for third parties to access this information. Such standardization advantageously provides an effective application program interface (API) that allow application programs to access the location data.

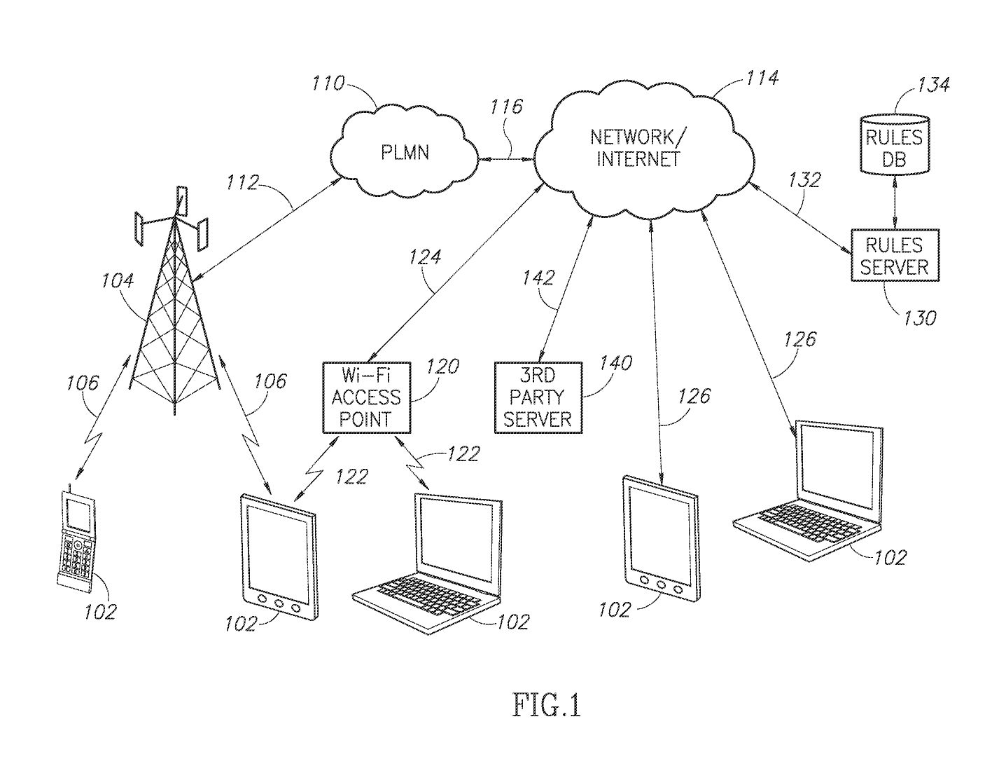

FIG. 1 illustrates an exemplary architecture of a system 100 that can provide such access control. FIG. 1 also shows a number of portable devices 102, such as a smart phone, computing tablet, laptop, and the like. However, a portable device may be considered any device capable of receiving a signal and sending information about such signal or its decoded meaning over any type of wireless network. Although certain functional features may vary from one device to another, for location control purposes, such as described herein, these may all be referred to simply as portable devices.

FIG. 1 illustrates a base station 104. Those skilled in the art will appreciate that many of the portable devices 102 can communicate with the base station 104. The base station 104 is intended to generically represent many forms of wireless communication provided by a service provider. This communication may take the form of 3G, 4G, WiMax, LTE, CDMA, WCDMA, and the like. The system 100 is not limited by the specific communication protocol utilized by the base station 104 or any of the portable devices 102 that communicate therewith.

The portable devices 102 communicate with the base station via wireless communication links 106. In turn, the base station 104 communicates with a public land mobile network (PLMN) 110 via a backhaul communication link 112. The PLMN 110 includes a number of conventional components, such as switches, routers, firewalls, and the like. In addition, the PLMN 110 includes a gateway to permit communication with a wide area network or Internet 114 via a communication link 116. For the sake of brevity, the conventional components (i.e., switches, routers, gateways and the like) are not shown in FIG. 1. Thus, the portable devices 102 can access the Internet network 114 via the PLMN 110.

In addition, the portable devices 102 include short range communication capabilities, such as IEEE 802.11, which is often referred to as WiFi. FIG. 1 illustrates a WiFi access point 120. The portable devices 102 can establish a wireless communication link 122 with the WiFi access point 120. In turn, the WiFi access point 120 is coupled to the network 114 via a communications link 124. Those skilled in the art will appreciate that the range of the WiFi access point 120 is considerably less than the typical range of the base station 104. However, WiFi access points 120 are common in locations such as shopping malls, airports, train stations, restaurants, coffee shops, hotels, businesses, libraries, public buildings, and the like. In some cases, the WiFi access point 120 is available to the public. For example, a coffee shop may offer free WiFi for its customers. Similarly, free WiFi access may be available in public buildings and libraries. In other situations, the WiFi access point 120 may be closed to the public and require payment for access. For example, some hotels provide free wireless access while others charge guests on a daily basis.

FIG. 1 also illustrates portable devices 102 that are coupled to the network 114 either directly or through a service provider (not shown). For example, the portable device 102 may be coupled to the network via a cable modem and cable service provider. In the examples illustrated in FIG. 1, the portable devices 102 are coupled to the network 114 via communication links 126.

Also illustrated in FIG. 1 is a rules server 130, which is coupled to the network 114 via a communication link 132. The rules server 130 controls a rules database 134. As will be described in greater detail below, the rules database 134 stores data governing the access to location data for individual wants of the portable devices 102. Although illustrated as the rules database 134, those skilled in the art will appreciate that any convenient form of data structure is suitable for this function. For example, the rules could be stored as a data table. Thus, the system 100 is not limited by the specific form of the rules database 134.

FIG. 1 also illustrates a third party server 140, which is coupled to the network 114 via a communication link 142. As will be described in greater detail below, the third party server represents any number of third parties that may wish to access location data for one or more of the portable devices 102.

FIG. 1 includes only a single base station 104 to illustrate connectivity between the portable devices 102 and the PLMN 110. However, those skilled in the art will appreciate that a typical PLMN 110 network includes thousands of base stations distributed throughout a large geographic region. In many examples, a network can provide nationwide coverage of the entire United States with the exception of relatively small remote geographic areas and areas with little or no population. Similarly, FIG. 1 illustrates only a single instance of the WiFi access point 120. However, those skilled in the art will appreciate that there are literally thousands of WiFi access points even in a relatively small geographic area such as a city. For the sake of clarity, FIG. 1 illustrates only the single base station 104 and the single WiFi access point 120.

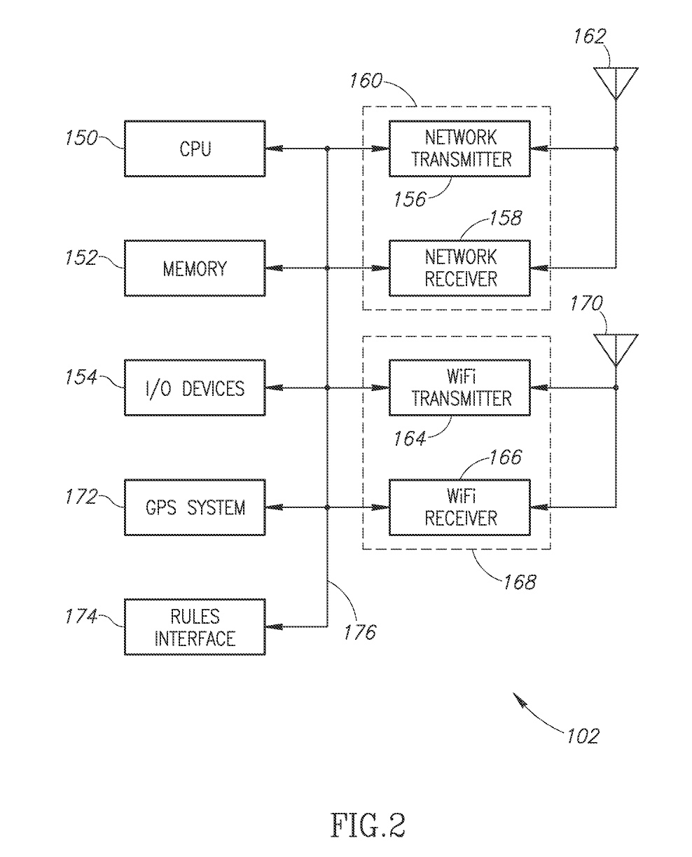

An example of a portable device 102 is illustrated in the block diagram of FIG. 2. The portable device 102 includes a central processing unit (CPU) 150 and a memory 152. The CPU 150 may be implemented as a conventional processor, digital signal processor, programmable gate array, application specific integrated circuit, or the like. The portable device 102 is not limited by the particular form of the CPU 150. Similarly, the memory 152 may include a combination of random access memory, read-only memory, flash memory, and the like. A portion of the memory 152 may be integrated into the CPU 150. The portable device 102 is not limited by the specific implementation of the memory 152.

In addition, the block diagram of FIG. 2 illustrates I/O devices 154. This is intended to generically represent a number of different possible input-output interfaces and devices, such as an audio input device (e.g. a microphone), an audio output device (e.g. speakers and/or headphone jack), display (e.g. monochromatic, color, touch screen, etc.), and controls (e.g. buttons). A typical portable device 102 may contain some or all of these various interfaces. For the sake of brevity, those are illustrated in FIG. 2 as the I/O devices 154.

The portable device 102 includes a network transmitter 156 and a network receiver 158. In some embodiments, these components may be combined to form a network transceiver 160. The network transmitter 156 and network receiver 158 are coupled to a network antenna 162 to form the wireless communication link 106 (see FIG. 1) with the base station 104.

The portable device 102 also includes a WiFi transmitter 164 and a WiFi receiver 166. These components may be combined to form a WiFi transceiver 168. The WiFi transmitter 164 and WiFi receiver 166 are coupled to a WiFi antenna 170 to form the wireless communication link 122 (see FIG. 1) with the WiFi access point 120.

Increasingly common in the portable device 102 is a GPS system 172. Those skilled in the art will appreciate that the GPS system 172 operates to receive data from a series of orbiting satellites to thereby determine the location of the portable device 102 with great accuracy. In some cases where there are an insufficient number of satellites that can be detected by the GPS system 172, the location of the portable device 102 can often be determined using a combination of data from the GPS satellites as well as other information, such as current base station/sector and the like.

In accordance with the present teachings, the portable device 102 also includes a rules interface 174. As will be described in greater detail below, the rules interface is user configurable to provide location information in accordance with the user's preferences.

Those skilled in the art will appreciate that some portions of the portable device 102 may be implemented as a series of computer instructions stored in the memory 182 and executed by the CPU 150. For example, the rules interface 174 may be implemented as a series of instructions stored in the memory 152. However, the rules interface 174 is illustrated as a separate block in the block diagram of FIG. 2 because it implements a separate function.

The various components illustrated in FIG. 2 are coupled together by a bus system 176. The bus system generically represents power and data distribution and may include a power bus, data bus, address bus, control bus, and the like. For the sake of brevity, those various buses are illustrated in FIG. 2 as the bus system 176.

The portable device 102 may provide direct, indirect, and proximate information about its location. Direct information can include, by way of example, latitude and longitude data provided by the GPS system 172 or another embedded positioning determination system such as time difference of arrival (TDOA) measurement systems. The GPS and TDOA data is generated automatically by the portable device 102. In addition to this automatically generated direct information, the portable device 102 can provide direct information in the form of user-entered location information. For example, the user can simply report his/her location using text or graphical input. For example, the user can enter text, such as “in Bellevue Square Mall,” to indicate their present location. Alternatively, the user may pinpoint their location graphically, such as on a map displayed on a display device of the I/O devices 154. The display on the portable device 102 can show a map that the user can manipulate using controls or a touch screen to display a certain region on the map and a user-determined display scale. The user can then graphically indicate their location on the map (e.g., the Seattle Space Needle).

Indirect information can also be used to derive the present location of the portable device 102. Indirect information can include, but is not limited to, identification of received cell sites with the possible addition of their signal characteristics, such as signal strength, absolute and/or relative timing, and the like. Those skilled in the art will appreciate that the portable device 102 typically communicates with multiple base stations 104 (see FIG. 1) at any given time. If the portable device 102 is in motion, such as travelling in a car, the signal strength of signals received from the base station 104 may decrease while the signal strength from another base station may increase. At some point in time, the portable device 102 will be handed off to the new base station with the higher signal strength. These varying signal strength measurements and the identification of the particular base station and sectors with which the portable device communicates are indicative of the distance of the portable device 102 from the base station and its approximate location based on the various signal strengths from multiple base stations. This location information can be used to provide a reasonably accurate determination of the present position of the portable device 102.

Another example of indirect information is identification of received wireless access points 120 with the possible addition of their signal characteristics, such as signal strength and other characteristics described above. Because the wireless access point 120 has a smaller range than a typical base station 104, the indirect information provided by the identification of the received wireless access points provides a reasonable estimate of the present location of the portable device 102.

Indirect information can also include the identification of any specialized location beacon transmitters with the possible addition of their signal characteristics, such as those described above. Furthermore, the identification of other transmitters, such as television signals, FM signals, and the like with the possible addition of their signal characteristics, such as those described above, may be used to provide indirect location information for the portable device 102. These are signals that can be received by the portable device 102. In turn, the portable device 102 reports on the reception of signals from one or more of these various transmitters.

Proximate information includes information such as a WiFi access point identifier with the possible addition of signal characteristics, such as those described above to determine that the portable device 102 is close to or within the coverage area of some transmitter or signal source. The signal source can be a radio frequency signal source, such as described above or it could be an audio signal that is sub-audible, a modulated light source either in the visible or invisible range of light, or the like. Indirect location information and proximate location information may have some degree of overlap. For example, indirect information may include signal strength information for three different wireless access points 120 (see FIG. 1) measured by the portable device 102. This location information is not direct information like a GPS indication of latitude and longitude, but the three signal strengths, along with the known location of the wireless access points 120, can be processed to provide a reasonably accurate, albeit indirect, location of the portable device 102. In contrast, proximate information may include, by way of example, the SSID for the same three wireless access points 120 discussed above. With this proximate information, along with the known location of the wireless access points 120, one can determine the approximate location of the portable device 102.

Those skilled in the art will appreciate that location information can be provided by a diverse number of sources. Some information is automatically generated, some is manually generated and some may be derived by combinations of location information from different sources. Using conventional techniques, a typical user has limited control over any location reporting. For example, the user can optionally enable or disable the GPS system 172 in FIG. 2. However, conventional systems provides no user control over the other various location information sources described above. The system 100 permits the user to set rules using the rules interface 174 in FIG. 2. The user can also set rules using other interfaces, such as fixed computer terminals, or using web browsers, voice recognition systems, or the like. The rules can include any parameters that either allow or disallow access to location information, such as time(s) of day, time of day range(s), day(s) of week, day of week range(s) or the like. In addition, the rules can be defined to include or exclude particular locations, such as locations described by an area or described by a place name (e.g., Bellevue Square Mall). A location described by an area may be defined by a radius based on a specified latitude and longitude, a polygon constructed from the latitude and longitude, or other means of “geofencing” to include or exclude areas in which location information will be reported. Similarly, particular areas can be included or excluded using the description of a place name to describe an area (e.g., Bellevue Square Mall, Yellowstone National Park, or the like).

In another example, location information may be allowed or disallowed on the basis of the third party requesting such information. For example, the user can specify that one individual (e.g., a spouse) can receive all location information while another party (e.g., a business solicitor) may be blocked from receiving any location information. The allowance or prohibition of location information need not be binary. That is, the user of the portable device 102 can allow some information to third parties while blocking other forms of location information. In one example, the user of the portable device 102 can allow or disallow information based on its type, such as direct, indirect, and proximate location information described above. In yet another embodiment, the user can invoke an immediate block all or allow all status for the location information to block all forms of location information from all parties or to allow all forms of location information to all parties. The portable device 102 can also be configured to immediately allow all location information to be used in the event of an emergency (e.g., 911) call.

The various rules described above are under user control and are stored in the rules database 134 (see FIG. 1) in association with a unique identifier for the portable device 102. For example, the portable device identifier could be an international mobile station identifier (IMSI), an international mobile equipment identifier (IMEI), a temporary mobile station identifier (TMSI), a packet TMSI (P-TMSI), a global unique terminal identifier (GUTI) a UserID or a hardware imbedded ID. The UserID can be any unique identification assigned to software on the portable device 102. The UserID can be changed remotely with or without user intervention. Similarly, hardware embedded identification may be either permanent or changeable through a firmware revision. The unique identification may be one or more of the identifiers discussed above. For added security, the unique identifier could be a hash of identification data for the particular portable device 102. Although these are examples of device identification, those skilled in the art will appreciate that any other means that uniquely identifies the portable device 102 may be satisfactorily used to implement the system 100. The system 100 is not limited by the particular form of the unique identification.

A typical user may have more than one portable device 102. For example, a user may have a smart phone, a laptop, and a computing tablet that are all different forms of portable devices 102. The system permits the user to specify a unique set of rules for each portable device 102 or to specify identical rule sets for all portable devices. To accomplish this, the user can copy the set of rules from one portable device 102 to another portable device. Alternatively, the rules database 134 may contain a single set of rules and include associated identifications for each of the portable devices 102.

The rules database 134 may also be configured to download the set of rules to the particular portable device 102 to permit the portable device to behave according to the user-specified rules. This may be useful if direct access to the rules database 134 becomes unavailable.

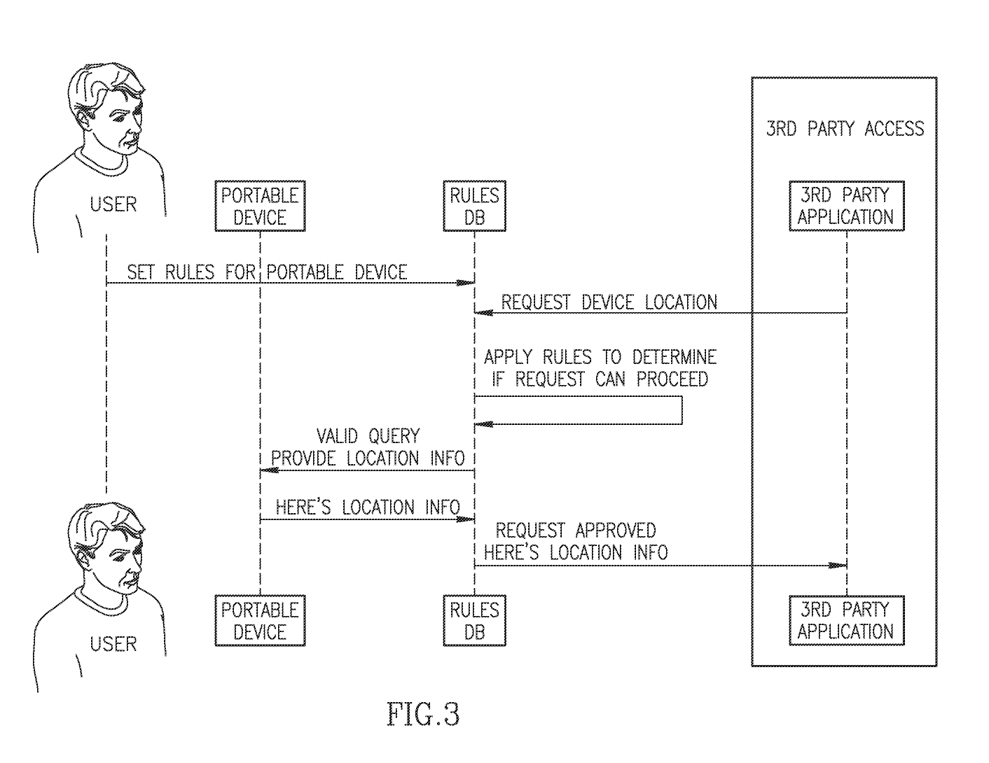

FIG. 3 illustrates a signaling protocol that can be used to access location information for the portable device 102 in accordance with the user-specified rules. By establishing a uniform signaling protocol, it is possible for software application programs to incorporate this application program interface (API) to obtain the desired location information. Prior to any third party access request, the user sets the rules for the portable device 102. As described above, those rules can be implemented directly using the rules interface 174 (see FIG. 2) on the portable device 102 itself or can be provided by a different computer, via web access, voice recognition, or the like. However the rules are generated, they are stored in the rules database 134 accessible through the rules server 130. At some subsequent point in time, a third party application sends a Request Device Location command to the rules server 130. The rules server 130 accesses the rules database 134 and applies the rules to determine whether the request can proceed. If the user has blocked all access, the rules server 130 returns a reply indicating that the request is disallowed or, alternatively, that location information is simply unavailable. If the rules allow for some or all of the available location information, a valid location query is sent by the rules server 130 to the portable device 102. In response, the portable device 102 provides its location information to the rules server 130 and rules database 134. In one embodiment, the portable device 102 may include a mechanism that prohibits direct access to direct or indirect information on the portable device except through the rules database. In addition, the portable device may allow direct access to certain applications, such as emergency (e.g., 911) calls without going through the rules database 134. Returning to FIG. 3, the location information from the portable device 102 is received by the rules server 130 and rules database 134 and the approved location information is provided to the third party application. As previously discussed, the rules database 134 can apply the rules dynamically to the location information received from the portable device 102 to eliminate any disallowed location information prior to passing the allowed location information to the third party application. Alternatively, the rules may be stored within the portable device 102 and applied at the portable device when the valid query is received. In this embodiment, the portable device only returns that information which is allowed by the user-defined rules. That location information can be passed directly to the third party application without further rules analysis by the rules server 130. Thus, the user can define the type of information that will be made available to any third party.

The actual location determination process is generally known and need not be described in detail herein. There are many different approaches depending on the available location information and the degree of accuracy required by the third-party application. Direct location information requires little or no additional processing to determine the location of the portable device 102.

Using the previous examples of indirect and proximate information from three wireless access points 120, for some purposes it may be sufficient to select the wireless access point 120 with the greatest signal strength and use the estimated area of coverage for that wireless access point as the location of the portable device 102. Alternatively, it is possible to look at estimated overlapping areas of coverage of the three wireless access points 120 with the estimated location of the portable device 102 in the intersection of the coverage areas of the three wireless access points. It is also possible to combine the various forms of location information to determine the location of the portable device 102 with greater accuracy. Using the example above where the indirect location information includes signal strengths of three wireless access points 120 and the proximate location information includes the SSID of the three wireless access points, it is possible to determine the location of the portable device 102 using proximate information to determine an overlap in coverage of the three wireless access points 120 and use the indirect signal strength measurements to determine the location of the portable device 102 within the overlapping areas of coverage. Thus, it can be appreciated that varying degrees of accuracy can be provided using one or more types of location information.

Those skilled in the art will appreciate that many different techniques may be applied to location information to determine the location of the portable device 102. The particular method for determining the location of the portable device may vary based on a number of factors, such as the initial location data itself, the relative computing power of the device performing the calculations, the need for greater or lesser accuracy in the location determination, the latency in determining the location, and the like. In one embodiment, the location information may be processed by the portable device 102 itself and the results provided to the rules server 130. In an alternative embodiment, the portable device 102 may provide all available location information to the rules server 130 and the location calculation performed by the rules server. In yet another embodiment, the location information may be provided to the third-party server 140 in its raw form so that the third-party application can perform the location determination.

In all cases, any location determination is based only upon the location information that is allowed in accordance with the set of rules previously specified by the user of the portable device 102. That is, if the portable device 102 performs the location calculations, it will do so only on the basis of the location information allowed by the user-specified rules. In the example where the rules server 130 performs the location determination, the portable device 102 may, in one embodiment, return all available location information. In this embodiment, the rules server will access the user-specified rules for the portable device 102 and will only use the location information allowed by those rules in its location determination. Alternatively, the portable device 102 may return only the location information permitted by the user-specified rules. In either embodiment, the rules server 130 will only use the allowed location information in its location determination. Similarly, if the third-party server 140 or third-party software application performs the location determination, it will do so based only on the location information allowed by the user-specified rules. In an exemplary embodiment, the third-party server 140 will only receive the location information permitted by the user-specified rules. This prevents the unauthorized use of location information not permitted by the user-selected rules. As one can appreciate, the advantage of allowing the third-party application to perform the location determination is that it may do so in accordance with its need for accuracy. Some applications may require a greater degree of specificity in the determination of the location of the portable device 102. Under these circumstances, the third-party application may perform more extensive calculations to accurately determine the location of the portable device 102. In other circumstances, less accuracy may be needed to satisfactorily operate the third-party software application. In this case, the third-party software application can perform less rigorous calculations to determine the location of the portable device 102 with less accuracy.

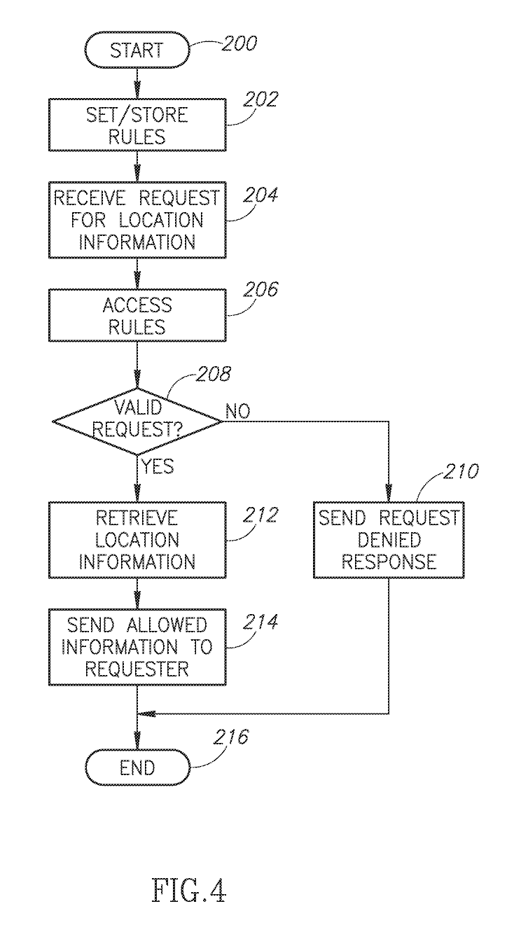

The operation of the system is illustrated in the flow chart of FIG. 4 where at a step 200, the user has a portable device 102 (see FIG. 1). In step 202, the user sets the location information access rules and those rules are stored in the rules database 134. As previously noted, a set of the rules may also be stored locally in the memory 152 (see FIG. 2) of the portable device 102.

In step 204, the system 100 receives a request for location information. In a typical embodiment, the request for location information may be made by a third-party application program. For example, an application program may allow users of a particular group, such as a soccer team, to monitor the location of the parents driving to a soccer game. In order to track various members of the group, the application program periodically sends a request to the portable devices 102 of those in the group to request their location information. As described above, such an application program may conveniently use the described API as a uniform mechanism to request location information. The convenience of the API allows various different forms of application programs to have a uniform mechanism for requesting such location information.

In step 206, the rules server 130 accesses the rules database 134 to retrieve the rules for the particular portable device 102. In decision 208, the rules server 130 determines whether the request is valid. That is, the rules server 130 must determine that the rules specified by the user of the portable device 102 permit some form of access to location information. If no access to location information is permitted, the result of decision 208 is NO and in step 210, the system can send a “request denied” response to the application requesting the location information and the process ends at 216.

If the rules for the particular portable device 102 permit access to location information, the result of decision 208 is YES and in step 212, the system retrieves location information from the portable device 102. In step 214, the system 100 sends the allowed information to the requester and the process ends at 216. As discussed above, the allowed information is location information that is allowed according to the user-specified rules. Those rules may be applied by the rules server 130 or applied locally by the portable device 102 itself.

In some circumstances, the portable device 102 may be out of communication range of any base station 104, WiFi access point 120, or the like. For example, the portable device may be powered down. Under such circumstances, there is no location information available from the portable device even though the rules database 134 (see FIG. 1) may permit the disclosure of such location information. Under these circumstances, the system 100 may return a message to the requester indicating that no data is available. Thus, the system 100 provides complete user control over the dissemination of location information for the portable device 102 in accordance with a variety of user-selectable rules. The system also allows great flexibility in altering those rules in accordance with the user's desires. Furthermore, the user has an effective master control to immediately allow access to all information or to block all information. Furthermore, the system allows overrides in the event of emergency calls.

The foregoing described embodiments depict different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality.

While particular embodiments of the present invention have been shown and described, it will be obvious to those skilled in the art that, based upon the teachings herein, changes and modifications may be made without departing from this invention and its broader aspects and, therefore, the appended claims are to encompass within their scope all such changes and modifications as are within the true spirit and scope of this invention. Furthermore, it is to be understood that the invention is solely defined by the appended claims. It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations).

Accordingly, the invention is not limited except as by the appended claims.

1. A system for control of location determination in a wireless communication device, comprising:
a network transmitter and network receiver and configured to communicate with a base station;
a non-network transmitter and non-network receiver and configured to communicate with a wireless access point;
a user-configurable rules interface configured to generate a set of location information disclosure rules to control the disclosure of all location information related to a current location of the wireless communication device; and
a controller configured to receive a request for location information related to the current location of the wireless communication device and to apply the set of location information disclosure rules prior to obtaining any location information to thereby determine if the disclosure of any location information requested in the request for location information is permitted by the set of information disclosure rules wherein the controller provides only location information allowed by the set of location information disclosure rules in response to the request.

2. The system of claim 1, further comprising a global positioning system (GPS) receiver configured to provide GPS position data wherein all location information comprises the GPS position data.

3. The system of claim 1, further comprising a data storage structure in the wireless communication device to store the set of location information disclosure rules.

4. The system of claim 3 wherein the controller is further configured to apply the set of location information disclosure rules from the data storage structure to the location information wherein the controller provides only location information allowed by the set of location information disclosure rules in response to the request.

5. The system of claim 1, further comprising a user-operable input device operable with the rules interface to permit user selection of the set of location information disclosure rules.

6. The system of claim 1 wherein the set of location information disclosure rules is selected from a group of possible rules comprising time of day and day of week.

7. The system of claim 1 wherein the set of location information disclosure rules is based on geographic location.

8. The system of claim 1 wherein the set of location information disclosure rules is based on an identity of an entity requesting the location information.

9. The system of claim 1 wherein the set of location information disclosure rules is based on an information type of the location information.

10. The system of claim 1 wherein the rules interface comprises a user-selectable option to block all location information.

11. The system of claim 1 wherein the rules interface comprises a user-selectable option to allow all location information.

12. A system for control of location information related to a wireless communication device, comprising:
a rules server;
a rules data storage structure communicatively coupled to the rules server and configured to store a set of location information disclosure rules in association with the wireless communication device; and
a first communication interface configured to receive a request for location information for the wireless communication device from a requestor, the rules server being configured to retrieve the set of location information disclosure rules associated with the wireless communication device from the rules data storage structure prior to obtaining any location information and determine whether the set of location information disclosure rules permits any location information for the wireless communication device to be disclosed, the rules server requesting location information only if the set of information disclosure rules indicates that the request for location information is permitted.

13. The system of claim 12, further comprising a second communication interface to transmit a request for location information to the wireless communication device and to receive location information therefrom, the first communication interface being further configured to provide permitted location information to the requestor.

14. The system of claim 13 wherein the first communication interface and the second communication interface are the same communication interface.

15. The system of claim 12 wherein the first communication interface is coupled to a network and receives the request for location information for the wireless communication device from the requestor via the network.

16. The system of claim 12 wherein the first communication interface is configured to receive user-selected set of location information disclosure rules and wherein the rules server is configured to store the user-selected set of location information disclosure rules in the rules data storage structure.

17. A method for control of location determination of a wireless communication device, comprising:
establishing a user-selectable set of location information disclosure rules governing disclosure of location data for the user wireless device;
storing the set of location information disclosure rules in association with the user wireless device;
receiving a request for location data for the user wireless device;
accessing the user-selected rules associated with the user wireless device;
prior to sending a request for location data to the user wireless device, applying the set of location information disclosure rules to the request for location data to determine if the request can proceed;
if the request can proceed, providing the request for location data to the user wireless device;
receiving location data from the user wireless device; and
providing allowed location data for the user wireless device in response to the request for the location data.

18. The method of claim 17 wherein storing the set of location information disclosure rules in association with the user wireless device comprises storing the set of location information disclosure rules in a data storage structure in association with a user identification for the user wireless device.

19. The method of claim 17 wherein storing the set of location information disclosure rules in association with the user wireless device comprises storing the set of location information disclosure rules in association with a device identification.

20. The method of claim 19 wherein the device identification comprises one of or a combination of identification components selected from a list of identification components comprising an International Mobile Station Identifier (IMSI), an International Mobile Equipment Identifier (IMEI), a Temporary Mobile Station Identifier (TMSI) a packet TMSI, a Global Unique Terminal Identifier (GUTI), a UserID assigned to a software program executing on the user wireless device, and a hardware embedded identification.

21. The method of claim 20 wherein the UserID assigned to the software program executing on the user wireless device is remotely alterable with or without user intervention.

22. The method of claim 20 wherein the hardware embedded identification is alterable.

23. The method of claim 17 wherein accessing the set of location information disclosure rules comprises establishing a communication link with a data storage structure configured to store the set of location information disclosure rules associated with the user wireless device.

24. The method of claim 17 wherein the set of location information disclosure rules is selected from a group of possible rules comprising time of day and day of week.

25. The method of claim 17 wherein the set of location information disclosure rules is based on geographic location.

26. The method of claim 17 wherein the set of location information disclosure rules is based on an identity of the requestor.

27. The method of claim 17 wherein the set of location information disclosure rules is based on an information type of the location information.

28. The method of claim 17 wherein the set of location information disclosure rules comprises a user-selectable option to block all location information.

29. The method of claim 17 wherein the set of location information disclosure rules comprises a user-selectable option to allow all location information.
